(19) United States
(12) Patent Application Publication
(10) Pub. No.: US 2013/0340717 A1
(43) Pub. Date: Dec. 26, 2013

(54) Methods and systems for conversion of single-fuel engine to multiple-fuel engine with diesel oxidation catalyst

(71) Applicants: Michael Avery, Menifee, CA (US); Roger Toale, Rialto, CA (US); George M. Malouf, Irvine, CA (US)

(72) Inventors: Michael Avery, Menifee, CA (US); Roger Toale, Rialto, CA (US); George M. Malouf, Irvine, CA (US)

(21) Appl. No.: 13/832,127

(22) Filed: Mar. 15, 2013

Related U.S. Application Data
(60) Provisional application No. 61/663,244, filed on Jun. 22, 2012.

(51) Int. Cl. F02D 41/30

(52) U.S. Cl. CPC F02D 41/30
USPC 123/478

(57) ABSTRACT

Engine conversion systems for converting an internal combustion engine from a single to a multiple-fuel engine are described. After engine conversion, an electronic control unit (ECU), can control amounts of a first fuel (for example, diesel) and amounts of a second fuel (for example, propane) that are provided to combustion chambers within the engine while operating in a multiple-fuel mode. The conversion system can include a diesel oxidation catalyst to reduce undesired exhaust emissions of the engine, and backpressure sensors for maintaining engine exhaust backpressure within a pre-conversion range of exhaust backpressures. The conversion systems can be configured for converting engines with mechanically-controlled or electronically-controlled fuel systems. The ECU can be configured to transition from operating in a multiple-fuel mode to a single-fuel mode if the ECU detects conditions that prevent the supply of predetermined amounts of the first and second fuels for detected operating conditions.

This application claims the benefit of U.S. Provisional Application No. 61/663,244, filed Jun. 22, 2012. U.S. Provisional Application No. 61/663,244 is hereby incorporated by reference.

### BACKGROUND

Vehicle emissions standards have been established by various entities such as the United States Environmental Protection Agency (EPA), the California Environmental Protection Agency Air Resources Board (CARB), and the European Union, to name but a few of those entities. Over time, those vehicle emissions standards have become more stringent. The manufacturers that desire to produce and sell internal combustion engines for use in geographical regions covered by the more stringent vehicle emission standards have been confronted with the challenge to meet and/or exceed the more stringent vehicle emission standards in order to be able to sell their engines.

The vehicle emission standards discussed above, as well as others, can be applicable to internal combustion engines that use a multiple-fuel control system. Methods and apparatus for operation of multiple-fuel engines are disclosed in U.S. Pat. No. 7,222,015 B2 and in U.S. Pat. No. 7,509,209 B2. U.S. Pat. No. 7,222,015 B2 and U.S. Pat. No. 7,509,209 B2 are each incorporated herein by reference.

### OVERVIEW

Example embodiments of systems and methods for converting a single-fuel engine to a multiple-fuel engine and example embodiments of a multiple-fuel engine converted from a single-fuel engine are described hereinafter.

In one respect, an example embodiment is arranged as an engine conversion system configured for conversion of an engine from a single-fuel engine using a first fuel to a multiple-fuel engine using the first fuel and at least a second, other, or subsequent fuel. Hereinafter, the second fuel refers to the second, other, or subsequent fuel. The system comprises (i) a first electronic control unit (ECU) configured to control delivery of supply amounts of the first fuel and supply amounts of the second fuel for combustion within the multiple-fuel engine, and (ii) a diesel oxidation catalyst (DOC) configured for installation within an exhaust system of the engine. The first ECU can include one or more inputs to receive data identifying operating characteristics for use in determining the supply amounts of the first fuel and the supply amounts of the second fuel. Conversion of the single-fuel engine to the multiple-fuel engine allows the multiple-fuel engine to operate in a single-fuel mode in which the engine uses the first fuel and in a multiple-fuel mode in which the engine uses the first fuel and the second fuel. The second fuel is a substitute for an amount of the first fuel and is injected as vapors into an air intake system of the multiple-fuel engine prior to entering a combustion chamber of the multiple-fuel engine.

In another respect, an example embodiment is arranged as an engine conversion system configured for conversion of an engine from a single-fuel engine using a first fuel to a multiple-fuel engine using the first fuel and a second fuel. The system comprises (i) an ECU configured to control delivery of supply amounts of the first fuel and supply amounts of the second fuel for combustion within the multiple-fuel engine, (ii) a DOC configured for installation within an exhaust system of the engine, (iii) a first back pressure sensor configured for installation within the exhaust system between combustion chambers of the engine and the DOC, and (iv) a second back pressure sensor configured for installation within the exhaust system between the DOC and an exhaust exist. The ECU can include one or more inputs to receive data identifying operating characteristics for use in determining the supply amounts of the first fuel and the supply amounts of the second fuel. Conversion of the single-fuel engine to the multiple-fuel engine allows the multiple-fuel engine to operate in a single-fuel mode in which the engine uses the first fuel and in a multiple-fuel mode in which the engine uses the first fuel and the second fuel. The second fuel is a substitute for an amount of the first fuel and is injected as vapors into an air intake system of the multiple-fuel engine prior to entering a combustion chamber of the multiple-fuel engine.

In yet another respect, an example embodiment is arranged as a method for converting a single-fuel engine that uses a first fuel to a multiple-fuel engine that uses the first fuel and a second fuel. This method comprises (i) attaching, to an engine exhaust system of the single-fuel engine, an exhaust temperature sensor, a first back pressure sensor, a second back pressure sensor, and a diesel oxidation catalyst, (ii) attaching, to a mechanical fuel control system of the single-fuel engine, a diesel rack actuator and a diesel rack position sensor, (iii) attaching, to the single-fuel engine, operator controls configured to select whether the multiple-fuel engine operates in a single-fuel mode or a multiple-fuel mode, (iv) attaching, to the single-fuel engine, a fuel supply system including a fuel storage device to store the second fuel, fuel supply lines to transport the second fuel within the fuel supply system, a solenoid valve, a fuel regulator, an injector rail assembly, one or more fuel injectors, and a mixer pin assembly, and (v) attaching, to the single-fuel engine, an electronic control unit, an air intake pressure sensor, an air intake temperature sensor, a throttle position sensor, a revolutions per minute (RPM) sensor, a fuel temperature sensor, a fuel pressure sensor, and an engine coolant temperature sensor.

In still yet another respect, an example embodiment is arranged as a method for converting a single-fuel engine that uses a first fuel to a multiple-fuel engine that uses the first fuel and a second fuel. This method comprises (i) attaching, to an engine exhaust system of the single-fuel engine, a first back pressure sensor, a second back pressure sensor, and a diesel oxidation catalyst, (ii) attaching, to the single-fuel engine, operator controls configured to select whether the multiple-fuel engine operates in a single-fuel mode or a multiple-fuel mode, (iii) attaching, to the single-fuel engine, a fuel supply system including a fuel storage device to store the second fuel, fuel supply lines to transport the second fuel within the fuel supply system, a solenoid valve, a fuel regulator, an injector rail assembly, one or more fuel injectors, and a mixer pin assembly, and (iv) attaching, to the single-fuel engine, a first electronic control unit (ECU) arranged to communicate with a second ECU that is part of the single-fuel engine via a data link. The first ECU receives sensor data from the second ECU to determine amounts of the second fuel to be supplied to combustion chambers within the engine, wherein the sensor data represents measurement data received from one or more sensors that were part of the single-fuel engine prior to conversion of the single-fuel engine to the multiple-fuel engine.

In still yet another respect, an example embodiment is arranged as a multiple-fuel engine produced by converting a single-fuel engine to the multiple-fuel engine. The single-fuel engine comprises an engine block that forms at least a portion of multiple combustion chambers. The single-fuel engine further comprises an air intake system, a fuel storage device storing a first fuel, a fuel pump for the first fuel, and an exhaust system for removal of exhaust gases produced, at least in part, within the engine block. The multiple-fuel engine comprises (i) a fuel storage device storing a second fuel, (ii) an ECU configured to control delivery of supply amounts of the first fuel and supply amounts of the second fuel for combustion within multiple-fuel engine, and (iii) a diesel oxidation catalyst (DOC) installed within the exhaust system. The ECU can include one or more inputs that receive data identifying operating characteristics of the multiple-fuel engine. The ECU can execute program instructions that use the received data to determine the supply amounts of the first fuel and the supply amounts of the second fuel. The multiple-fuel engine can operate in a single-fuel mode in which the multiple-fuel engine uses the first fuel. The multiple-fuel engine can operate in a multiple-fuel mode in which the multiple-fuel engine uses the first fuel and the second fuel. The second fuel is a substitute for an amount of the first fuel and is injected as vapors into the air intake system of the multiple-fuel engine.

These as well as other aspects and advantages will become apparent to those of ordinary skill in the art by reading the following detailed description, with reference where appropriate to the accompanying drawings. Further, it should be understood that the embodiments described in this overview and elsewhere are intended to be examples only and do not necessarily limit the scope of the invention.

### BRIEF DESCRIPTION OF THE DRAWINGS

Example embodiments are described herein with reference to the drawings, in which:

FIG. 1 is a block diagram of a multiple-fuel engine in accordance with an example embodiment;

FIG. 2 is a block diagram of a multiple-fuel engine in accordance with another example embodiment;

FIG. 3 is a block diagram of an electronic control unit (ECU) in accordance with an example embodiment;

FIG. 4 is a flow chart illustrating a set of functions that can be carried out in accordance with an example embodiment;

FIG. 5 is a flow chart illustrating a set of functions that can be carried out in accordance with an example embodiment; and

FIG. 6 is a block diagram of a system in accordance with an example embodiment.

### DETAILED DESCRIPTION

### I. Introduction

This description describes multiple example embodiments of systems and methods pertaining to internal combustion engines (or more simply “engines”) that are operable in single and multiple-fuel modes. At least one of the example embodiments pertains to a method of converting a single-fuel engine (operable in a single-fuel mode but not a multiple-fuel mode) into a multiple-fuel engine (operable in single and multiple-fuel modes). At least one other example embodiment pertains to a multiple-fuel engine.

The single-fuel engine is an internal combustion engine that can use a first fuel (for example, a primary fuel) to operate and can use a compression-ignition scheme to ignite the first fuel. Upon conversion from a single-fuel engine to a multiple-fuel engine, the multiple-fuel engine can use the first fuel when operating in the single-fuel mode and use the first fuel and a second, other, or subsequent fuel when operating in the multiple-fuel mode. The converted engines can use the compression-ignition scheme while operating in either the single or multiple-fuel modes.

The first fuel for the described embodiments comprises a liquid diesel fuel. The first fuel can be injected into a combustion chamber for ignition in a liquid state. The second fuel for the described embodiments is preferably a Liquid Propane Gas (LPG) such as HD-10 propane, but can be another type of LPG or another type of fuel, such as, but not limited to, 100% propane, compressed natural gas (CNG), butane, or a biofuel. In addition to HD-10 propane, other examples of the second, other or subsequent fuel being a combination of multiple-fuels are possible. For instance, the second fuel can comprise a fuel combination in which 50% of the second fuel is propane and the other 50% is butane. The second fuel in advantageous embodiments enters the combustion chamber for ignition in a gaseous state (for example, a vapor).

The amount of second fuel consumed while the engine operates in the multiple-fuel mode is a substitute for an amount of first fuel that does not have to be consumed while the engine operates in the multiple-fuel mode. Therefore, operating the engine in the multiple-fuel mode can reduce the amount of first fuel used to operate the engine.

During operation of the multiple-fuel engine in the multiple-fuel mode, the use of the second fuel as a substitute for some amount of the first fuel, and the use of a diesel oxidation catalyst (DOC), can lead to a significant reduction in harmful emissions generated by the engine. Additionally, since certain types of the second fuel, such as LPG fuel, typically costs less than diesel fuel, a significant cost savings can be realized by using the engine in the multiple-fuel mode rather than the single-fuel mode.

The single-fuel engine can include a first fuel system to deliver the first fuel to combustion chambers within an engine block at which the first fuel is ignited. The multiple-fuel engine can include the first fuel system and a second fuel system. The second fuel system can deliver the second fuel to an air intake system that supplies intake air to the combustion chambers within the engine block at which both the first and second fuels can be ignited. In that way, the second fuel can mix with intake air prior to entering the combustion chambers. The first fuel system can be modified while converting a single-fuel engine to a multiple-fuel engine. The multiple-fuel engine uses pilot ignition (for example, compression ignition of the first fuel) to ignite the second fuel. In that way, converting the engine to a multiple-fuel engine does not require installing a spark ignition system, such that the cost of an engine conversion system is significantly less as compared to an engine conversion system that includes a spark ignition system.

Each single-fuel engine and multiple-fuel engine can comprise multiple engine systems including, but not limited to, the air intake system, the first fuel system, the second fuel system (after conversion of the single-fuel engine), a fuel combustion system including the combustion chambers and cylinder heads, an engine control system, an exhaust system, and an emissions system. Each engine can be classified in various ways. For example, each engine can be classified by engine displacement size and/or by engine manufacturer. As another example, each engine can be classified by the type of fuel pump used within the first fuel system. In that regard, an engine can classified as a mechanically-controlled fuel pump engine or an electrically-controlled fuel pump engine. The manners in which each of those types of fuel pumps is controlled during a multiple-fuel mode differ from one another, as discussed below.

As yet another example, each engine can be classified as a stationary engine or a mobile engine. A stationary engine can comprise an engine that does not propel a vehicle in which the stationary engine is located. Stationary engines typically operate at fixed locations and can be moved from one fixed location to another fixed location. Stationary engines can be operated while the engine is in motion from one fixed location to another fixed location, but the engine does not provide the means to move the engine between those locations. A mobile engine comprises an engine that is installed within a vehicle propelled by the engine. The vehicle in which a mobile engine is installed can comprise a semi-tractor, or some other type of vehicle.

### II. Engine Conversion

A plurality of engine manufacturers manufactures single-fuel engines. The components that can be attached to a single-fuel engine to convert the single-fuel engine to a multiple-fuel engine are described in this description. The various components attached to any given single-fuel engine to convert that engine to a multiple-fuel engine are referred to herein as an engine conversion system.

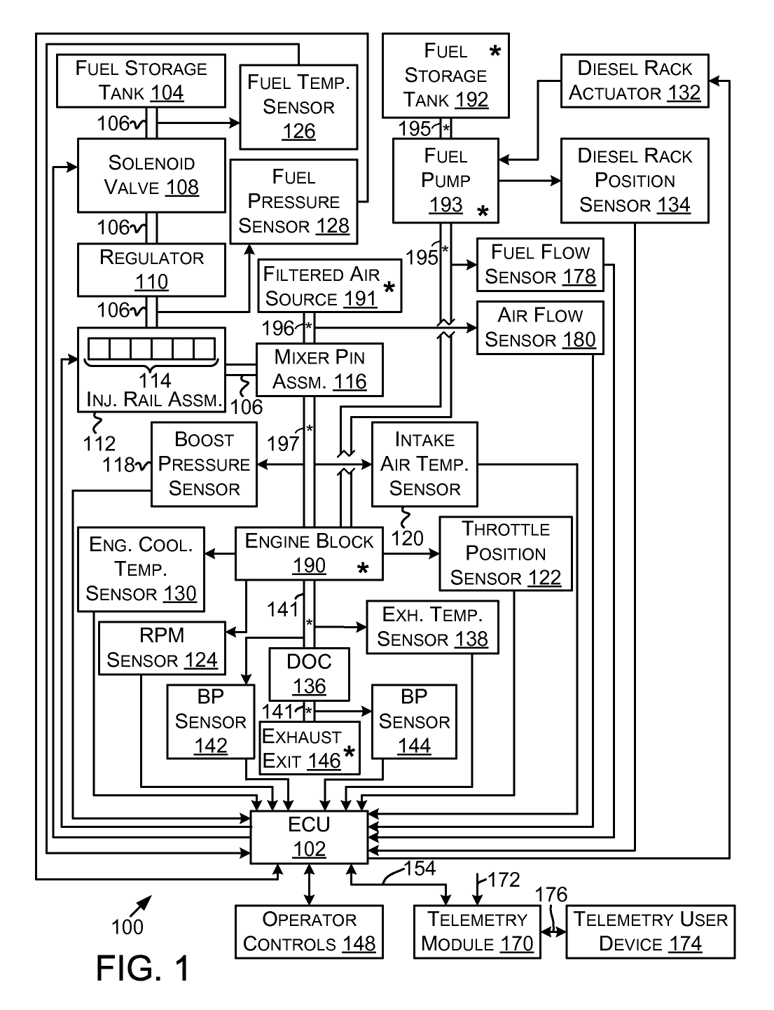

FIG. 1 illustrates an example multiple-fuel engine 100 converted from a single-fuel engine to the multiple-fuel engine using an engine conversion system. The components of engine 100 that can be a part of the single-fuel engine, prior to its conversion to a multiple-fuel engine, are labeled with an asterisk (that is, “*”). In that regard, prior to its conversion, the single-fuel engine can include (i) an engine block 190 that has multiple combustion chambers and that attaches to one or more cylinder heads, (ii) a filtered air source 191 to provide filtered air into the combustion chambers of engine block 190, (iii) intake air transport lines 196, 197, (iv) a fuel storage device 192 to store the first fuel, (v) a fuel pump 193 to provide the first fuel from fuel storage device 192 to engine block 190, (vi) fuel lines 195 for transporting the first fuel, (vii) an exhaust exit 146 (for example, an exhaust tail pipe or exhaust stack at which engine exhaust is vented to the atmosphere outside of the engine), and (viii) exhaust lines 141 for transporting exhaust away from engine block 190 towards exhaust exit 146.

A person skilled in the art will understand that converting a single-fuel engine to a multiple-fuel engine can include attaching components of the engine conversion system to at least a portion of one engine system. That same person will also understand that one or more components of the engine conversion system can be used with a multiple-fuel engine without being attached to at least a portion of one engine system. For example, operator controls 148, discussed below, can be located within a passenger compartment of a vehicle that can include a mobile multiple-fuel engine or at a control station that is remote from a stationary multiple-fuel engine. Operator controls 148 can communicate wirelessly (for example, via a radio frequency air interface) with other portions of the multiple-fuel engine.

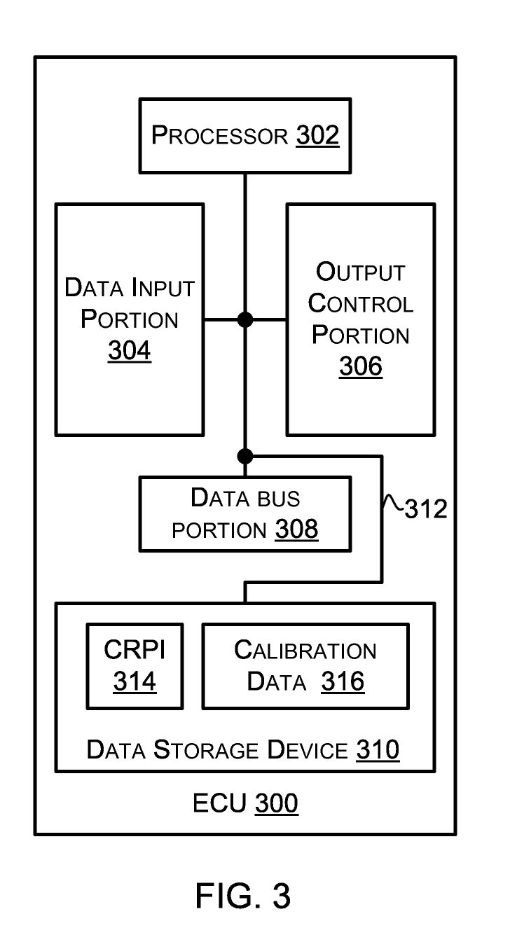

In accordance with an example embodiment, an engine conversion system can comprise the components of engine 100 that are shown in FIG. 1 without an asterisk. The engine conversion system shown in FIG. 1 includes an electronic control unit (ECU) 102. ECU 102 can be arranged as ECU 300 (shown in FIG. 3) such that ECU 102 includes, among other components, a data input portion 304 and an output control portion 306.

Data input portion 304 can receive information signals from various sensors of a multiple-fuel engine (for example, from the sensors of multiple-fuel engine 100). The information signals can represent and/or comprise data that identify operating characteristics for use in determining the supply amounts of the first and second fuels during use of engine 100.

The sensors shown in FIG. 1 include (i) a boost pressure sensor 118 that generates boost-pressure data for identifying pressures of intake air within the air intake system of engine 100, (ii) an intake air temperature (IAT) sensor 120 that generates IAT data for identifying temperatures of intake air within the air intake system of engine 100, (iii) a throttle position (TP) sensor 122 that generates TP data for identifying positions of a throttle of engine 100, (iv) a revolutions per minute (RPM) sensor 124 that generates RPM data for identifying the RPM at which engine 100 is operating (for example, the engine speed), (v) a fuel temperature (FT) sensor 126 that generates FT data for identifying temperatures of the second fuel, (vi) a fuel pressure (FP) sensor 128 that generates FP data for identifying pressures of the second fuel, (vii) an engine coolant temperature (ECT) sensor 130 that generates ECT data for identifying temperatures of coolant within a cooling system of engine 100, (viii) a diesel rack position (DRP) sensor 134 that generates (DRP) data for identifying a position of a fuel rack at fuel pump 193, (ix) an exhaust temperature (ET) sensor 138 that generates ET data for identifying temperatures of exhaust gas within an exhaust system of engine 100, and (x) back pressure (BP) sensors 142, 144 that generate BP data for identifying pressures within exhaust lines 141.

One or more sensors connected to a multiple-fuel engine can transmit information signals to a data input portion 304 wirelessly using an air interface established between the sensor and data input portion 304. Additionally or alternatively, one or more sensors connected to a multiple-fuel engine can transmit information signals to data input 304 using a wired link that connects the sensor to data input portion 304. The wired links and networks referred to in this description can include, but are not limited to, copper wires or optical fibers.

Output control portion 306 can output signals (for example, electrical signals pulled down to an electrical ground level, electrical signals pulled up to battery voltage level, or a pulse width modulated (PWM) signal) to control various components of engine 100. As an example, the controlled components can include (i) a solenoid valve 108 to prevent the flow of the second fuel from storage device 104 to regulator 110, (ii) second fuel injectors 114 that meter the supply amount of the second fuel supplied to mixer pin assembly 116, and (iii) a diesel rack actuator 132 that controls position of a fuel rack at fuel pump 193.

The engine conversion system for engine 100 can include a fuel storage device 104, such as a fuel storage tank, to store the second fuel prior to being provided to the combustion chambers. Fuel storage device 104 can include a fuel inlet to receive the second fuel as a liquid or a vapor and an outlet vapor port to provide the second fuel as a vapor to a fuel supply line 106 that is arranged to carry the second fuel vapor downstream from fuel storage device 104 towards engine block 190. Fuel storage device 104, similar to fuel storage device 192, can vary in size, shape, and engine mounting, and one or more of fuel storage devices 104 and 192 can be fitted with heating blankets or heating strips to aid in maintaining adequate fuel pressure in cold weather operation.

The engine conversion system for engine 100 can include a set of fuel supply lines 106 that comprises several fuel supply lines that connect to components of engine 100, such as fuel storage device 104, solenoid valve 108, fuel regulator 110, injector rail assembly 112, fuel injectors 114 that inject the second fuel into an air intake system, and mixer pin assembly 116. Those fuel supply lines can be made of any of a variety of materials, such as steel (for example, stainless steel), aluminum, rubber, or some other material. For turbocharged engines, mixer pin assembly 116 can be installed downstream of the turbocharger outlet providing compressed air for combustion.

The engine conversion system for engine 100 can include a solenoid valve 108 that ECU 102 can control to prevent or allow the flow of second fuel within engine 100. As an example, solenoid valve 108 can be located in the fuel supply system between the fuel storage device 104 and fuel regulator 110. In accordance with that example, ECU 102 can control solenoid valve 108 to allow the flow of second fuel from fuel storage device 104 to fuel regulator 110 when ECU 102 has not detected a current reason to prevent the flow of second fuel. Alternatively, ECU 102 can control solenoid valve 108 to prevent the flow of second fuel from fuel storage device 104 to fuel regulator 110 when ECU 102 has detected a current reason to prevent the flow of second fuel (for example, engine exhaust temperature has exceeded a maximum exhaust temperature threshold).

The engine conversion system for engine 100 can include fuel regulator 110 to regulate a pressure of the second fuel supplied from fuel storage device 104. For example, fuel regulator 110 can reduce a pressure of the second fuel supplied from fuel storage device 104 if the pressure exceeds a threshold fuel pressure. In accordance with an embodiment in which the second fuel comprises propane, the fuel regulator 110 can be referred to as a propane regulator.

The engine conversion system for engine 100 can include an injector rail assembly 112 having one or more injectors 114 that are operable to inject a metered amount of second fuel into a fuel supply line 106 leading to mixer pin assembly 116. Injectors 114 (for example 4 to 6 injectors) can be bottom-feed injectors or top feed-injectors, but are not so limited. Each injector can include a supply port to receive second fuel, an injector gate valve, and an injection port. ECU 102 can be configured to use output control portion 306 to control an amount of time the injection port of each injector is open and/or an area that the injection port is opened when metering the amount of second fuel.

The engine conversion system for engine 100 can include a mixer pin assembly 116 for introducing the second fuel metered by injectors 114 into the air intake system of engine 100. As an example, mixer pin assembly 116 can comprise a tube approximately 6 inches long with a 0.5 inch inside diameter, and a plurality of orifices for fuel to pass through from mixer pin assembly 116 into the air intake system. The arrangement of mixer pin assembly 116 within the air intake system can cause the air within the air intake system to tumble which can improve mixing of the air and fuel exiting the orifices of mixer pin assembly 116.

The engine conversion system for engine 100 can include a boost pressure sensor 118 that is used in measuring the pressure of air within the air intake system. For turbocharged engines, boost pressure sensor 118 can be located downstream of the turbocharger so that boost pressure sensor 118 measures boost pressure within the air intake system. ECU 102 can determine the measured air pressure and use the air pressure measurement in determining amounts of the first fuel to be supplied to fuel pump 193 and amounts of the second fuel to be supplied to mixer pin assembly 116 for subsequent delivery of those fuel supplies to the combustion chambers so that a desired ratio of air and fuel is provided to the combustion chambers.

The engine conversion system for engine 100 can include an intake air temperature (IAT) sensor 120 that is used in measuring the air temperature within the air intake system of engine 100. As that air temperature changes, sensor data provided by IAT sensor 120 to ECU 102 can change. ECU 102 can determine the measured intake air temperature and use the intake air temperature measurement in determining amounts of the first fuel to be supplied to fuel pump 193 and amounts of the second fuel to be supplied to mixer pin assembly 116 for subsequent delivery of those fuel supplies to the combustion chambers so that a desired ratio of air and fuel is provided to the combustion chambers.

The engine conversion system for engine 100 can include a throttle position sensor (TPS) 122 that is used in measuring a position of a throttle that indicates operator demand for fuel. For stationary diesel engines embodiments, TPS 122 can be used in measuring the position of an electronically-controlled throttle. For mobile diesel engine embodiments, TPS 122 can be used in measuring a position of a throttle configured to be moved in response to an operator changing positions of an accelerator pedal. Other examples of how TPS 122 is used to measure a throttle position are also possible. ECU 102 can determine the measured throttle position and use the throttle position measurement in determining amounts of the first fuel to be supplied to fuel pump 193 and amounts of the second fuel to be supplied to mixer pin assembly 116 for subsequent delivery of those fuel supplies to the combustion chambers so that a desired ratio of air and fuel is provided to the combustion chambers.

The engine conversion system for engine 100 can include an RPM sensor 124 that is used in measuring revolutions per minute (RPM) of engine 100. RPM sensor 124 can generate and provide to ECU 102 a signal that ECU 102 can use to measure engine RPM. Additionally or alternatively, RPM sensor 124 can alter an output signal of ECU 102 and ECU 102 can detect changes to the output signal so as to measure engine RPM. ECU 102 can determine the measured RPM and use the RPM measurement in determining amounts of the first fuel to be supplied to fuel pump 193 and amounts of the second fuel to be supplied to mixer pin assembly 116 for subsequent delivery of those fuel supplies to the combustion chambers so that a desired ratio of air and fuel is provided to the combustion chambers.

The engine conversion system for engine 100 can include a fuel temperature sensor 126 that is used in measuring a temperature of the second fuel. ECU 102 can use second fuel temperature measurement data for various reasons including, but not limited to, determining amounts of the first fuel to be supplied to fuel pump 193 and amounts of the second fuel to be supplied to mixer pin assembly 116 for subsequent delivery of those fuel supplies to the combustion chambers so that a desired ratio of air and fuel is provided to the combustion chambers, and/or causing engine 100 to transition from a single-fuel mode to a multiple-fuel mode or from a multiple-fuel mode to a single-fuel mode.

The engine conversion system for engine 100 can include a fuel pressure sensor 128 that is used in measuring a pressure of the second fuel. ECU 102 can use second fuel pressure measurement data for various reasons including, but not limited to, determining amounts of the first fuel to be supplied to fuel pump 193 and amounts of the second fuel to be supplied to mixer pin assembly 116 for subsequent delivery of those fuel supplies to the combustion chambers so that a desired ratio of air and fuel is provided to the combustion chambers, and/or causing engine 100 to transition from a single-fuel mode to a multiple-fuel mode or from a multiple-fuel mode to a single-fuel mode.

The engine conversion system for engine 100 can include an engine coolant temperature (ECT) sensor 130 that is used in measuring the temperature of engine coolant within engine 100. ECT sensor 130 responds to temperature changes of engine coolant, such as a conventional engine coolant that conforms to American Society for Testing and Materials (ASTM) standard D-4985 or to ASTM standard D-6210. By way of example, ECT sensor 130 can include a thermistor, an electrical voltage terminal, and an electrical ground terminal. ECU 102 can use ECT sensor data for various reasons including, but not limited to, determining amounts of the first fuel to be supplied to fuel pump 193 and amounts of the second fuel to be supplied to mixer pin assembly 116 for subsequent delivery of those fuel supplies to the combustion chambers so that a desired ratio of air and fuel is provided to the combustion chambers, and/or causing engine 100 to transition from a single-fuel mode to a multiple-fuel mode or from a multiple-fuel mode to a single-fuel mode.

The engine conversion system for engine 100 can include a fuel flow sensor 178 (for example, one or more fuel flow sensors) that is used in measuring an amount of fuel flow. Fuel flow sensor 178 can measure an amount the first fuel and/or an amount of the second, other, or subsequent fuel. Fuel flow sensor 178 can be installed at and/or within any of a variety of components such as a fuel storage tank or a fuel line. Fuel flow sensor 178 can, for example, measure and/or provide signals for measuring an amount of fuel flowing into fuel flow sensor 178, an amount of fuel flowing out of fuel flow sensor 178, or a difference between the amount of fuel flowing into fuel flow sensor 178 and the amount of fuel flowing out of fuel flow sensor 178.

As an example, a fuel flow amount determined from using fuel flow sensor 178 can be an amount of fuel injected into a multiple fuel engine each time fuel is injected into the engine. As another example, a fuel flow amount determined from using fuel flow sensor can be an amount of fuel consumed by an engine over a given amount of time, such as 24 hours or some other amount of time. Other examples of the fuel flow amount are also possible.

The engine conversion system for engine 100 can include an air flow sensor 180 (for example, one or more air flow sensors) that is used in measuring an amount of air flow for engine 100. Air flow sensor 180 can be installed at and/or within any of a variety of components such as filtered air source 191, an intake air transport line, or some other component. Air flow sensor 180 can, for example, measure and/or provide signals for measuring an amount of air flowing into air flow sensor 180, an amount of fuel flowing out of air flow sensor 180, or a difference between the amount of air flowing into air flow sensor 180 and the amount of air flowing out of air flow sensor 180.

A telemetry user device 174, displaying information signals generated by air flow sensor 180, can indicate an operating status of multiple-fuel engine 100 with respect to its air flow, such as a normal or restricted air flow. A user learning, from telemetry user device 174, that engine 100 is operating with a restricted air flow can suspect that an air filter within engine 100 needs to be replaced in order to have engine 100 operating with a normal air flow.

A data storage device 310 within ECU 102 can include a minimum coolant temperature threshold and a maximum coolant temperature threshold. A processor 302 within ECU 102 can execute computer-readable program instructions (CRPI) 312 to convert the sensor input from ECT sensor 130 to an engine coolant temperature value and to compare that value to the minimum and maximum coolant temperature thresholds. In response to determining that the engine coolant temperature value represents an engine coolant temperature below the minimum coolant temperature threshold or greater than the maximum coolant temperature threshold, ECU 102 can responsively cause engine 100 to transition from operating in a multiple-fuel mode to a single-fuel mode.

The engine conversion system for engine 100 can include a diesel rack actuator 132 to control a position of a mechanically-controlled diesel pump fuel rack. A single-fuel engine that uses a mechanically-controlled diesel pump fuel rack can include an air/fuel ratio controller to control a position of the diesel fuel rack. In order to allow ECU 102 to control the amount of diesel fuel provided to the combustion chambers of engine block 190, conversion of the single-fuel engine to engine 100 can include removing and/or disconnecting the air/fuel ratio controller and installing the diesel rack actuator 132 to fuel pump 193. ECU 102 controls a position of diesel rack actuator 132 while engine 100 operates in single-fuel mode and while engine 100 operates in multiple-fuel mode.

The engine conversion system for engine 100 can include a diesel rack position sensor 134 for use in detecting rack position of a diesel pump rack. Diesel rack position sensor 134 can generate and provide to ECU 102 a signal that ECU 102 can use to detect the diesel pump rack position. Additionally or alternatively, diesel rack position sensor 134 can alter an output signal of ECU 102 and ECU 102 can detect changes to detect the diesel pump rack position. As an example, ECU 102 can use an output of diesel rack position sensor 134 to detect that the position of the diesel pump rack is at (i) a minimum fuel position at which fuel pump 193 provides a minimum amount of diesel fuel, (ii) a maximum fuel position at which fuel pump 193 provides a maximum amount of diesel fuel, or (iii) a position between the minimum and maximum fuel positions at which fuel pump 193 provides an amount of diesel fuel greater than the minimum amount of diesel fuel but less than maximum amount of diesel fuel.

The engine conversion system for engine 100 can include a diesel oxidation catalyst (DOC) 136 that contributes to reducing the level of certain emissions (for example, particulate matter (PM), carbon monoxide, and nitrogen oxides (NOx) emissions) emitted by engine 100 while it operates in the single or multiple-fuel mode. The DOC 136 can contributes to reducing PM emissions by as much as 50% and reducing NOx emissions by as much as 25% when engine operates in the dual mode as compared to the PM and NOx emission levels of engine 100 prior to its conversion to a multiple-fuel engine.

DOC 136 can be installed in the exhaust system of engine 100, such as at a location between an exhaust manifold attached to engine block 190 and an exhaust muffler. For embodiments in which engine 100 is a turbocharged engines, DOC 136 can be installed downstream of the turbocharger exhaust outlet and the exhaust muffler.

DOC 136 is available from AirTek, Inc. (also known as CATCO) having an office in Hobart, Ind., United States. DOC 136 can comprise CATCO's DOC having CATCO part number DP1075. The example engine conversion system including the DP1075 has been certified by the State of California Air Resources Board for use on certain off-road compression-ignition engines and applications.

The DP1075 DOC can include a substrate and active catalysts (for example, active metals). The active catalysts can include platinum (PT), palladium (Pd), and rhodium (Rh) and the composition of active catalysts can comprise 40 grams/foot³ of Pd, 2 grams/foot³ of Rh, and 5 grams/foot³ of Pt. The DP1075 DOC can includes a metallic substrate having an outside diameter equal to or approximately 10.42 inches, a length equal to or approximately 4.5 inches, and 2 beds. The DP1075 DOC has a volume or approximate volume per bed of 389 cubic inches and a total converter volume or approximate total converter volume of 767 cubic inches, and the substrate has a cell geometry having or approximately having 300 cells per square inch and a wall thickness or approximate wall thickness of 0.06 millimeters.

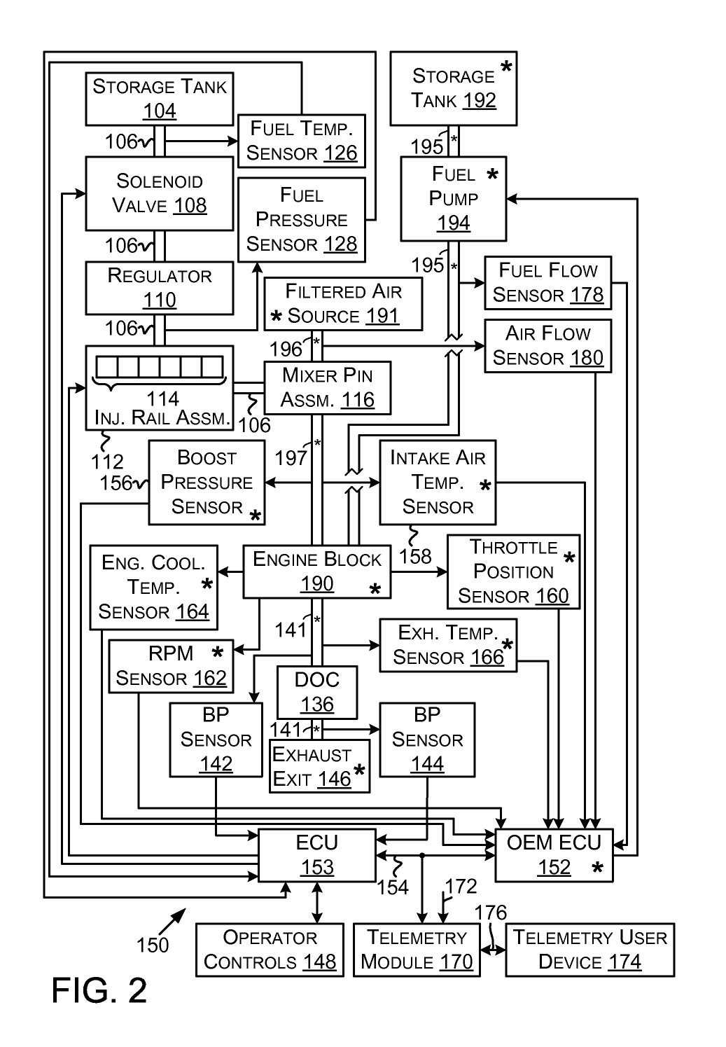

Other CATCO DOCs can be used as DOC 136 (shown in FIG. 1 and FIG. 2) to achieve reductions in the same type of emissions that are reduced by using DOC DP1075. The other CATCO DOC can include a substrate, such as a metallic or ceramic substrate, and the substrate can have various cell geometries defined by a cell wall thickness and a number cells per square inch, such as 200, 300, or 400 cells per square inch. The substrate can be washcoated with an alumina mixed oxide diesel wash coat or some other washcoat.

In accordance with another particular DOC from CATCO, the substrate can have an outside diameter equal to or approximately 7.66 inches, a length equal to or approximately 4 inches, and 2 beds. The volume or approximate volume per each of those beds is 184.33 cubic inches and the total converter volume or the approximate total converter volume is 368.66 cubic inches, and the substrate has a cell geometry in which there are 400 cells per square inch and the wall thickness or the approximate wall thickness is 0.165 millimeters. The active catalysts loaded into this DOC embodiment can comprise Pd, Rh, and iridium (Ir) and the composition of those loaded catalysts can be 35 grams/foot³ of Pd, 2 grams/foot³ of Rh, and 13 grams/foot³ of Ir.

The engine conversion system for engine 100 can include an exhaust temperature sensor (ETS) 138 that is used in measuring the temperature of engine exhaust gases. By way of example, ETS 138 can include a thermistor, an electrical voltage terminal, and an electrical ground terminal. ECU 102 can include an input for receiving a sensor input from ETS 138. Data storage device 310 within ECU 102 can include a maximum exhaust temperature threshold. Processor 302 within ECU 102 can execute CRPI 314 to convert the sensor input from ETS 138 to an exhaust temperature value and to compare that value to the maximum exhaust temperature threshold. In response to ECU 102 determining the exhaust temperature value represents an exhaust temperature greater than the maximum exhaust temperature threshold, ECU 102 can responsively cause engine 100 to transition from operating in a multiple-fuel mode to a single-fuel mode. In response to ECU 102 determining an exhaust temperature value(s) represent an exhaust temperature less than the maximum exhaust temperature threshold, ECU 102 can allow engine 100 to transition from operating in the single-fuel mode to the multiple-fuel mode.

The engine conversion system for engine 100 can include back pressure sensors 142, 144 used in the measurement of exhaust gases and particles that have exited engine block 190 and is/are heading downstream towards exhaust exit 146. ECU 102 can use back pressure measurement data for various reasons including, but not limited to, determining amounts of the first fuel to be supplied to fuel pump 193 and amounts of the second fuel to be supplied to mixer pin assembly 116 for subsequent delivery of those fuel supplies to the combustion chambers so that a desired ratio of air and fuel is provided to the combustion chambers, and/or causing engine 100 to transition from a single-fuel mode to a multiple-fuel mode or from a multiple-fuel mode to a single-fuel mode.

The engine conversion system for engine 100 can include operator controls 148 that allow a user to select whether engine 100 operates in the single-fuel mode or the multiple-fuel mode. Operator controls 148 can include a system on/off switch to make that user selection. Upon detecting the system on/off switch is changed from the off position to the on position, ECU 102 can determine if the operating conditions of engine 100 meet conditions defined for engine 100 to operate in the multiple-fuel mode. If the defined conditions are met, ECU 102 causes engine 100 to transition from operating in the single-fuel mode to the multiple-fuel mode. Upon detecting the system on/off switch is changed from the on position to the off position, if engine 100 is operating in the single-fuel mode, ECU 102 causes engine 100 to continue operating in the single-fuel mode, whereas if engine 100 is operating in the multiple-fuel mode, ECU 102 causes engine 100 to transition from operating in the multiple-fuel mode to the single-fuel mode.

Operator controls 148 can include one or more engine status indicators. The status indicators can include light emitting diodes, incandescent light bulbs, a liquid crystal display (LCD), or some other type of visual or audible indicator. By way of example, the status indicators can include a green and amber lights controlled by the output control portion 306 of ECU 102. ECU 102 can cause the green light to illuminate (for example, turn on) and the amber light to not illuminate (for example, turn off) when engine 100 is operating in a multiple-fuel mode. ECU 102 can cause the amber light to illuminate and the green light to not illuminate in response to ECU 102 determining that engine 100 is operating in a single-fuel mode.

For stationary engines, operator controls 148 can be mounted at and/or within an engine control box including engine control devices. For mobile engines, operator controls 148 can be mounted within a passenger compartment of a vehicle in which the mobile engine is installed. As an example, the operator controls 148 can be mounted in and/or on the vehicle's instrument panel.

Telemetry module 170 can be configured to receive information signals from other components of a multiple-fuel engine, such as engine 100, and to transmit information signals to one or more telemetry user-devices 174. The information signals transmitted by telemetry module 170 can be identical to or a modification of the information signals received at telemetry module 170. Generating the modified information signals can comprise, for example, the telemetry module 170 converting an analog information signal to a digital information signal, changing a scale of the received information signal, combining multiple separate information signals into a single information signal, or parsing an information signal with data from multiple sensors to an information signal with data from a single sensor.

Receiving the information signals at telemetry module 170 can occur in various ways. For example, telemetry module 170 can receive the information signals from ECU 102 via a data bus 154. As another example, telemetry module 170 can receive the information signals, from one or more sensors of a multiple-fuel engine, at discrete inputs 172 of telemetry module 170. Each of those discrete inputs can be connected to a respective sensor of a multiple-fuel engine. One or more of discrete inputs 172 can be electrically connected to wiring that connects a sensor of a multiple-fuel engine to a data input portion 304 of ECU 102. As yet another example, telemetry module 170 can receive the information signals using an RF air interface between a wireless sensor and telemetry module 170.

Transmitting the information signals can occur by transmitting the signals over a network 176. Network 176 can comprise a wired network, such as a public switched telephone network, a Local Area Network, or a broadband cable network. Additionally or alternatively, network 176 can comprise a wireless network, such as a cellular telephone network or an IEEE 802.11 network.

Some or all of the telemetry user-devices 174 can be configured to present (for example, visually, audibly, and/or haptically) information signals received from telemetry module 170. Any one or more telemetry user-devices 174 can be arranged as a wireless communication device, such as a cellular telephone or a pager. Any one or more telemetry user-devices 174 can be arranged as a personal computer, such as a laptop or desktop computer. Other examples of the telemetry user-device 174 are also possible. The information signals presented at a telemetry user-device 174 can inform a user as to the operating characteristics of a multiple-fuel engine.

U.S. Pat. No. 7,222,015 B2 and U.S. Pat. No. 7,509,209 B2 are assigned to Engine Control Technologies (ECT), LLC, which is located in Fayetteville, Ga., United States. One or more components of engine 100 can be obtained from ECT LLC and/or configured as described in either of the two aforementioned patents, each of which is incorporated herein by reference.

Table 1 identifies components of engine 100 and components described in U.S. Pat. No. 7,222,015 B2 and U.S. Pat. No. 7,509,209 B2. Each component of engine 100 shown in Table 1 can be referred by the name of the corresponding ECT component identified in Table 1.

TABLE 1

| Engine (100) Component | ECT Component |
|---|---|
| ECU (102) | ECU (45, 110) |
| Fuel storage device (104) | Tank (15) |
| Fuel supply lines (106) | Conduit (16) |
| Solenoid valve (108) | High Pressure Shutoff (19) |
| Fuel regulator (110) | Pressure Regulator (20) |
| Fuel injectors (114) | Gas Metering Device (22, 119) |
| Mixer pin assembly (116) | Air/Gas Mixer (17) |
| Boost pressure sensor (118) | Boost Pressure Sensor (50, 113, 123) |
| Intake air temperature sensor (120) | Manifold Temperature Sensor (124) |
| Throttle position sensor (122) | Accelerator Sensor (37, 104) |
| RPM sensor (124) | RPM sensor (39, 102) |
| Fuel Temperature Sensor (126) | Gas Temperature Sensor (47, 112) |
| Fuel Pressure sensor (128) | Gas Pressure Sensor (46, 111) |
| Engine coolant temperature | Coolant Sensor (38, 103) |
| sensor (130) | |
| Diesel rack actuator (132) | Diesel Fuel Control Actuator (52) |
| Exhaust temperature sensor (138) | Exhaust Temperature Sensor |
| | (40, 114) |
| Operator Controls (148) | Selector Switch (53, 56) |
| Engine Block (190) | Engine (11) |
| Fuel Storage Device (192) | Diesel Fuel Storage Tank (27) |
| Fuel Pump (193) | Diesel Fuel Pump (28) |

### III. Engine Conversion System Embodiments

Diesel engine manufacturers manufacture various types of diesel engines having different engine components. Accordingly, when converting diesel engines from being single-fuel engines to multiple-fuel engines, the set of components from the engine conversion system used to carry out that conversion can vary based on the type of diesel engine to be converted.

Table 2 identifies the components of the engine conversion system and whether each of those components is used when converting three different types of single-fuel engines referred to as engine type 1, engine type 2, and engine type 3. By way of example, engine type 1 is a diesel engine with a mechanical fuel control system. Engine type 2 is a diesel engine with an electronic fuel control system. Engine type 3 represents other types of diesel engines, some of which can use a mechanical or electronic fuel control system. The word “Yes” in the engine type columns represents that the component of that row in Table 2 can be used to convert that engine type from a single-fuel engine to a multiple-fuel engine, whereas the word “No” in the engine type columns represents that the component of that row in Table 2 does not need to be used to convert that engine type from a single-fuel engine to a multiple-fuel engine. The word “Optional” in Table 2 indicates that the engine conversion system component of that row can be used in converting an engine to a multiple-fuel engine, but does not need to be used to convert that engine to a multiple-fuel engine.

TABLE 2

| | Engine type 1 | Engine type 2 | |
|---|---|---|---|
| Engine Conversion System | Mechanical Fuel | Electronic Fuel | |
| Components | Control System | Control System | Engine type 3 |
| ECU (102) | Yes | Yes | Yes |
| Fuel storage device (104) | Yes | Yes | Yes |
| Fuel supply lines (106) | Yes | Yes | Yes |
| Solenoid valve (108) | Yes | Yes | Yes |
| Fuel regulator (110) | Yes | Yes | Yes |
| Injector rail assembly (112) | Yes | Yes | Yes |
| Fuel injectors (114) | Yes | Yes | Yes |
| Mixer pin assembly (116) | Yes | Yes | Yes |
| Boost pressure sensor (118) | Yes | Yes | Optional |
| Intake air temperature sensor (120) | Yes | No | Optional |
| Throttle position sensor (122) | Yes | No | Optional |
| RPM sensor (124) | Yes | No | Optional |
| Fuel Temperature Sensor (126) | Yes | Yes | Optional |
| Fuel Pressure sensor (128) | Yes | Yes | Optional |
| Engine coolant temperature sensor | Yes | No | Optional |
| (130) | | | |
| Diesel rack actuator (132) | Yes | No | Optional |
| Diesel rack position sensor (134) | Yes | No | Optional |
| Diesel oxidation catalyst (136) | Yes | Yes | Yes |
| Exhaust temperature sensor (138) | Yes | Yes | Optional |
| Back pressure sensor (142) | Yes | Yes | Optional |
| Back pressure sensor (144) | Yes | Yes | Optional |
| Operator controls (148) | Yes | Yes | Yes |
| Telemetry Module (170) | Yes | Yes | Optional |
| Fuel flow sensor (178) | Yes | Yes | Optional |
| Air flow sensor (180) | Yes | Yes | Optional |

In Table 2, each sensor is listed as Optional for Engine type 3. Each of those sensors is configured to generate and/or alter a signal that can be used by an ECU in measuring parameters for use in determining amounts of first and second fuels to be supplied for combustion. A person having ordinary skill in the art will understand that if ECU 102, when operating on the multiple-fuel engine, is able to obtain sensor data for a given parameter from one or more components that is attached to the engine before being converted to a multiple-fuel engine, then a sensor of the Engine Conversion System Components that is configured to provide that same sensor data is not required for the engine conversion.

The set of components used to convert engine type 1 contains the entire set of components of the example engine conversion system. The set of components used to convert engine type 2 contains a subset of the components used to convert engine type 1 since intake air temperature sensor 120, throttle position sensor 122, RPM sensor 124, diesel rack actuator 132, and diesel rack position sensor 134 are not needed for conversion of the type 2 engine to a multiple-fuel engine.

A person having ordinary skill in the art will understand that other subsets of the example engine conversion system components can also be used to completely convert a single-fuel engine to a multiple-fuel engine. At least some of those other subsets of components are represented in Table 2 by the column for Engine type 3.

Various example methods for converting a single-fuel engine to a multiple-fuel engine are evident from viewing Table 2. As a general example, a method for converting a single-fuel engine to a multiple-fuel engine comprises installing each component for a given engine type shown in Table 2. As a particular example, a method for converting a single-fuel engine (for example, engine type 1) to a multiple-fuel engine comprises attaching each conversion system component listed in Table 2 to the single-fuel engine. Attaching a conversion system component to a single-fuel engine can include attaching the component directly to the engine or indirectly to the engine. Indirect attachment of an engine system component to the single-fuel engine can, for example, comprise attaching the component to a vehicle chassis to which the single-fuel engine is attached, attaching the component within a passenger compartment of a vehicle within which the single-fuel engine is attached, or attaching the component to an engine stand that supports the engine for stationary usage of the engine. Other examples of indirectly attaching an engine conversion system component to a single-fuel engine are also possible.

Next, FIG. 2 illustrates an example multiple-fuel engine 150 converted from a single-fuel engine via an example engine conversion system. Engine 150 corresponds to engine type 2 listed in Table 2. Accordingly, fuel pump 194 comprises an electrically controlled fuel pump. The components of engine 150 that were part of a single-fuel engine are labeled with an asterisk. In that regard, prior to its conversion, the single-fuel engine included (i) an engine block 190, (ii) a filtered air source 191 to provide filtered air into a combustion chamber at least partially formed by engine block 190, (iii) a fuel storage device 192 to store the first fuel, (iv) fuel pump 194 to provide the first fuel from first fuel storage device 192 to engine block 190, (v) boost pressure sensor 156, (vi) intake air temperature sensor 158, (vii) throttle position sensor 160, (viii) RPM sensor 162, (ix) engine coolant temperature sensor 164, (x) exhaust temperature sensor 166, and (xi) an original equipment manufacturer (OEM) ECU 152.

The fuel storage device 104, fuel supply lines 106, solenoid valve 108, regulator 110, injector rail assembly 112, fuel injectors 114, mixer pin assembly 116, DOC 136, back pressure sensors 142, 144, exhaust exit 146, and operator controls 148 can be arranged as those same numbered components described above with regard to FIG. 1. ECU 153 for engine 150 can be identical to ECU 102 for engine 100. Alternatively, ECU 153 can differ from ECU 102. For example, ECU 153 can comprise computer-readable program instructions (CRPI) and calibration data that differ from the CRPI and calibration data within ECU 102. A person skilled in the art will understand that the CRPI instructions within ECU 153 can be configured for receiving sensor data via data bus 154 rather than via data input portion 304.

### IV. Electronic Control Unit (ECU)

FIG. 3 is a block diagram of an example ECU 300 in accordance with an example embodiment. As shown in FIG. 3, ECU 300 includes a processor 302, a data input portion 304, an output control portion 306, a data bus portion 308, and a computer-readable data storage device 310, each of which can be connected by a system bus or another mechanism 312. ECU 102 and ECU 153 can be arranged like ECU 300.

Processor 302 can comprise one or more general purpose processors (for example, INTEL single core microprocessors or INTEL multicore microprocessors) and/or one or more special purpose processors (for example, digital signal processors). Processor 302 is operable to execute computer-readable program instructions (CRPI) 314 stored in data storage device 310.

Data storage device 310 can comprise a non-transitory computer-readable storage medium readable by processor 302. The computer-readable storage medium can comprise volatile and/or non-volatile storage components, such as optical, magnetic, organic or other memory or disc storage, which can be integrated in whole or in part with processor 302. Data storage device 310 can also store calibration data 316.

CRPI 314 comprises a variety of program instructions executable by processor 302. For example, CRPI 314 can comprise program instructions to determine whether a user has selected an engine to operate in the multiple or single-fuel mode. As another example, CRPI 314 can comprise program instructions to determine precise fueling requirements for the engine, based, as least in part, on the operating characteristics determined by processor 302 and the current fueling mode of the engine. Precisely controlling the amount of fuel(s) used by the engine can include repeatedly determining amounts of the first and second fuels to be provided by the multiple-fuel engine while operating in either the single or multiple-fuel mode, and causing output control portion 306 and/or data bus portion 308 to output signals that cause the first and second fuel systems to provide the determined amounts of fuel. Precisely controlling the amount of fuel(s) used by the engine can further include preventing the over-fueling of the engine so that harmful exhaust emissions do not exceed emission limits and so that engine damage is avoided. The determined amount of second fuel for the single-fuel mode is no fuel (that is, zero fuel).

As yet another example, CRPI 314 can comprise program instructions to determine whether the multiple-fuel engine should transition from the multiple-fuel mode to the single-fuel mode based on one or more operating characteristics of the engine determined by processor 302. Calibration data 316 can comprise respective threshold data associated with each sensor shown in FIG. 1 and/or FIG. 2. Processor 312 can execute CRPI 314 to compare data received from each of those sensors to the respective threshold data associated with those sensors so as to determine whether the engine should transition from the multiple-fuel mode to the single-fuel mode or to allow the engine to transition from the single-fuel mode to the multiple-fuel mode if a user has selected multiple-fuel mode operation. The respective threshold data can include minimum, maximum, or minimum and maximum thresholds for each sensor that generates data that ECU 102 or ECU 153 can use to determine operating characteristics of an engine.

As a more particular example, processor 302 can execute CRPI 314 to cause the engine to transition to the single-fuel mode in response to receiving data generated by fuel pressure sensor 128 that indicates the pressure of the second fuel is below a minimum fuel pressure threshold, which could indicate that the amount of second fuel in storage device 104 is below a threshold fuel amount. Conversely, once processor 302 determines that the pressure of the second fuel meets or exceeds the minimum fuel pressure, absent some other operating characteristic to prevent the engine from operating in the second fuel mode, processor 302 can operate CRPI 314 to cause the engine to switch back to operating in the multiple-fuel mode.

As still yet another example, CRPI 314 can comprise program instructions to run diagnostic routines with regard to components of the multiple-fuel engines. Those diagnostic routines can, for example, determine that the component(s) are working improperly and/or outside of desired operating ranges. For instance, the diagnostic routines can be executed to determine that an electrical circuit connected to one of back pressure sensors 142, 144 is shorted to an electrical ground or to battery voltage or open-circuited. Detecting one or more of the improper operating ranges can result in ECU 300 causing the multiple-fuel engine to transition from the multiple-fuel mode to the single-fuel mode. The diagnostic routines can also be executed to inform a user via operator controls 148 or telemetry module 170 that some diagnostic routine has detected a condition that can require servicing of the multiple-fuel engine.

As still yet another example, CRPI 314 can comprise program instructions to determine an air flow amount and/or a fuel flow amount. Those program instructions can use measurement data generated via fuel flow sensor 178 and/or air flow sensor 180. Additionally or alternatively, those program instructions can determine an air flow amount and/or a fuel flow amount based on other inputs received at data input portion 304 or data bus portion 308. As an example, execution of CRPI 314 can determine a fuel flow amount by multiplying an amount of time, such as an amount of milliseconds, that fuel injector(s) inject fuel times a known amount of fuel injected per a base amount of time, such as a number of milliliters per millisecond.

Calibration data 316 can comprise various computer-readable program instructions executable by processor 302 and written specifically for one or more convertible engines, but not all convertible engines, and/or data that can include, but is not limited to, computer-readable data usable by processor 302 while executing CRPI 314 and/or determining which program instructions of CRPI 314 are to be executed. For example, CRPI 314 can include program instructions to be executed if a multiple-fuel engine uses a mechanical fuel control system to inject the first fuel and other program instructions to be executed if a multiple-fuel engine uses an electrical fuel control system to inject the first fuel. Processor 302 can refer to calibration data 316 to determine which of those program instructions are to be executed for the multiple-fuel engine.

As another example, calibration data 316 can comprise calibration data that allows a multiple-fuel engine to operate such that a power curve established for a single-fuel engine is retained or substantially retained after that engine is converted to a multiple-fuel engine and operates in either the single or multiple-fuel mode. That calibration data can be configured for one or more different types of the second fuel. Processor 302 can be used to select the appropriate calibration data based on the type of second fuel being used by the multiple-fuel engine. Table 3 illustrates power curve measurement data obtained by operating a 1999 Caterpillar 3406 series engine in a single-fuel mode and a multiple-fuel mode.

TABLE 3

| | Operating | Diesel | Propane |
|---|---|---|---|
| Power Curve Measurement | Mode | Percentage | Percentage |
| 288 hp @ 1,852 RPM | Single-fuel | 100% | 0% |
| 288 hp @ 1,856 RPM | Multiple-fuel | 50% | 50% |
| 875 lb-ft torque @ 1,328 RPM | Multiple-fuel | 100% | 0% |
| 875 lb-ft torque @ 1,329 RPM | Single-fuel | 50% | 50% |

In addition to selecting appropriate calibrations for a given engine or fuel, calibration data 316 can include calibration data that can be varied to the fuel ratio used by the multiple-fuel engine for one or more operating points of the engine and/or calibration data that can be varied to change the amount of fuel to be used by the multiple-fuel engine for one or more operating points of the engine. Moreover, CRPI 314 can comprise program instructions to change the fuel ratio and fuel amount calibration data. Those program instructions can be executed in response to receiving change-fuel-calibration data. The change-fuel-calibration data can be transmitted to the multiple-fuel engine from telemetry user device 174, from a programming device connected locally to the engine, such as via data bus 154. Using telemetry user device 174 to change the fuel ratio and/or fuel amount calibration data allows a user to alter engine operating characteristics without being near the engine.

As yet another example, calibration data 316 can be configured so that the multiple-fuel engine, regardless of whether operating in the single-fuel mode or the multiple-fuel mode, operates such that the exhaust emissions of the engine are within the emission standards established for the engine. In that regard, an engine and/or the engine conversion system comprising an ECU with that calibration data is certifiable to meet the emission standards established for the engine. As an example, an engine conversion system in accordance with the example embodiments has been certified by the California Environmental Protection Agency Air Resources Board via a B-series executive order such that the system can be sold within California for 2011 and older engines built by Caterpillar, Cummins, Detroit Diesel, John Deere, Kubota, MTU Detroit Diesel, Navistar and Volvo having a displacement between 2.5 and 15 liters and a horsepower rating between 100 and 675 HP.

Data bus portion 308 can comprise logic for transmitting data messages across a data bus (for example, data bus 154) and for receiving data messages received at ECU 102 via the data bus. As an example, data bus 154 can be arranged as a data bus that carries out communications according to a predetermined communications protocol, such as the J1939 communications protocol defined by the Society of Automotive Engineers (SAE) or some other communications protocol. Data bus portion 308 can be contained with processor 302.

A portion of CRPI 314 can be executed in response to the data messages received at data bus portion 308 from OEM ECU 152. The data messages received at data bus portion 308 can comprise data representing sensor measurement signals that OEM ECU 152 received from sensors attached to the multiple-fuel engine prior to its conversion from a single-fuel engine.

Another portion of CRPI 314 can be executed so as cause data bus portion 308 to transmit data messages across data bus 154 to OEM ECU 152. The data message transmitted across data bus 154 from data bus portion 308 can be destined for OEM ECU 152 and can contain fuel request data that causes OEM ECU 152 to control the fuel system for the first fuel to provide the requested amount of fuel to the combustion chambers.

### V. Example Operation

The example multiple-fuel engines, converted from a single-fuel engine, burn two fuels in the combustion process. The multiple-fuel engine can first inject the second fuel into a pressurized air duct upstream of the intake manifold that connects to engine block 190. The second fuel mixes with air and the air and second fuel mixture enters combustion chambers via a cylinder head and is then compressively heated in the combustion chamber. At a point near top dead center in each compression stroke, the first fuel (for example, liquid diesel fuel) is injected into the combustion chamber at which the first and second fuels are to be ignited. Compression heating of the first fuel initiates combustion of both the first and second fuels, which causes the piston that compressed the first and second fuels down in the power stroke of the engine.

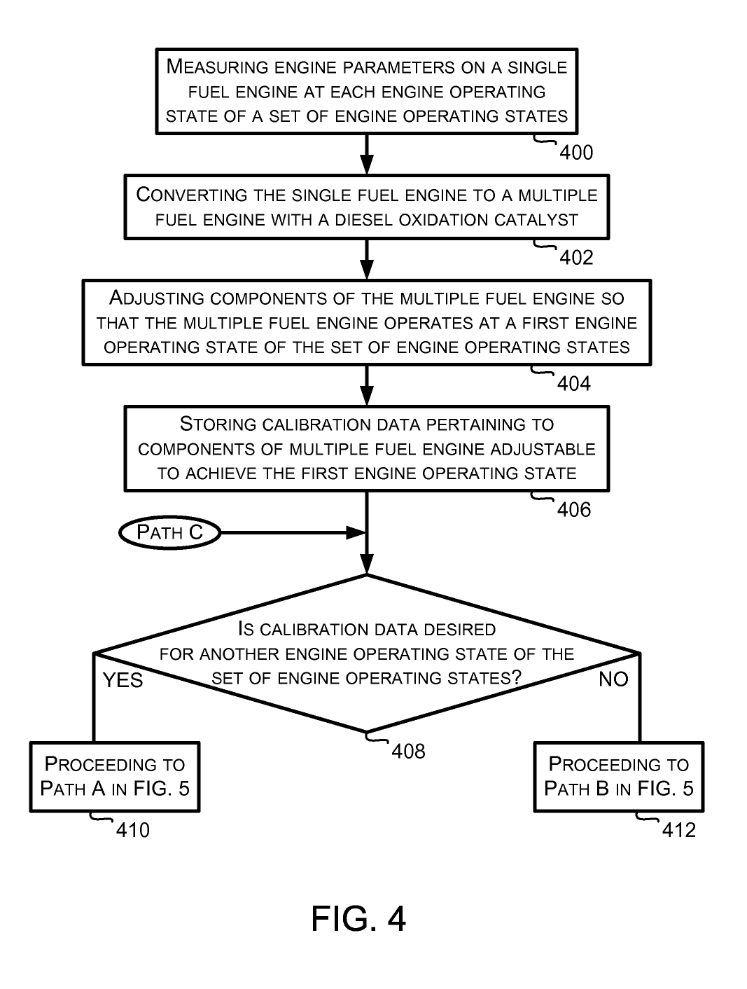

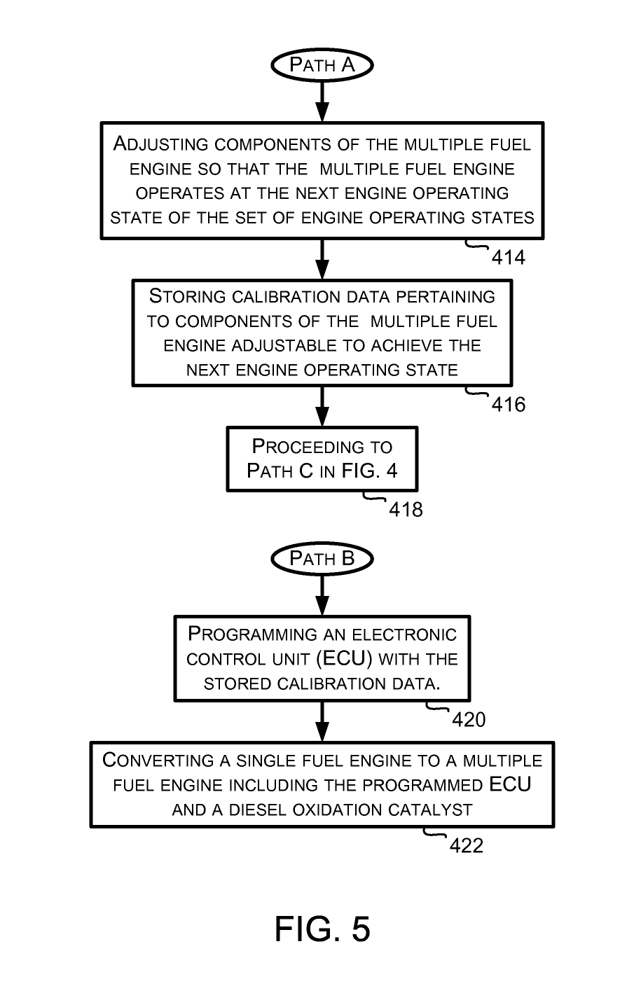

FIG. 4 and FIG. 5 depict a flow chart illustrating a set of functions that can be carried out in accordance with an example embodiment. In FIG. 4, block 400 includes measuring engine parameters of a single-fuel engine at each engine operating state of a set of engine operating states. Each engine operating state can be defined by one or more engine operating characteristics. The one or more engine operating characteristics can include, but are not limited to, the current engine RPM, the current engine horsepower, the current engine torque, and the load applied to the engine.

Various devices can be used to apply a load to the engine. For example, an engine dynamometer that applies a load to the engine or a chassis dynamometer that applies a load to a full powertrain including the engine can be used to apply a load to the single-fuel engine. As another example, a device operable to apply an electrical load can apply an electrical load to a single-fuel engine configured to operate as a generator.

The measured engine parameters can include parameters associated with engine components that are controllable by the engine and/or an ECU so as to change the operating characteristics and thus the operating state of the engine. The measured engine parameters can include, but are not limited, to a mechanical diesel fuel pump rack position and a throttle position.

Table 4 includes example engine operating characteristics and engine parameters for 2 example operating states. In Table 4, the throttle data is represented as a percentage of a wide-open throttle (WOT) position, and the intake air pressure is represented in pounds per square inch (PSI). A person skilled in the art will understand that a larger number of operating states can be defined for an embodiment using a mobile diesel engine than the number of operating states that might be defined for an embodiment using a stationary diesel engine.

TABLE 4

| Engine | | | | | | | |
|---|---|---|---|---|---|---|---|
| Oper- | | | | | | | |
| ating | Engine Operating Characteristics | | | | Engine Operating Parameters | | |
| State | | Horse- | | | Rack | Throttle | Intake air |
| N.A. | RPM | power | Torque | Load | Position | Position | Pressure |
| 1 | 1,800 | 160 hp | 460 | 50% | 31% | 17% | 16 PSI |
| | | | lb. ft. | | | WOT | |
| 2 | 1,900 | 165 hp | 452 | 50% | 32% | 18% | 16.4 PSI |
| | | | lb. ft. | | | WOT | |

Next, block 402 includes converting the single-fuel engine to a multiple-fuel engine with a diesel oxidation catalyst. Conversion of the single-fuel engine can include attaching, to the single-fuel engine, the components of an engine conversion system for a type 1 engine shown in Table 2 above or a subset of that engine conversion system. The diesel oxidation catalyst attached to the single-fuel engine can be configured as DOC 136.

Next, block 404 includes adjusting components of the multiple-fuel engine so that the multiple-fuel engine operates at a first operating condition of the set of operating conditions. The components adjusted at block 404 can include an engine component that was part of the single-fuel engine, such as a diesel fuel pump. The components adjusted at block 404 can also include an engine component that was added to the single-fuel engine during its conversion to a multiple-fuel engine, such as fuel injectors 114. ECU 300 can execute CRPI 314 to adjust the components.

Next, block 406 includes storing calibration data pertaining to components of the multiple-fuel engine adjustable to achieve the first engine operating state. The calibration data for the first engine operating state can be stored in non-transitory computer-readable data storage device, which can be, but is not necessarily, located in an ECU arranged like ECU 300. The stored calibration data can include data representing the engine operating characteristics set and/or measured for the first engine operating state, and data representing the engine operating parameters measured for the first engine operating state.

Next, block 408 is a decision block asks the question is calibration data desired for another operating condition of the set of operating conditions. A yes response to the question of block 408 (in other words, if additional calibration data is desired) leads to block 410, which includes proceeding to path A in FIG. 5.

Turning to FIG. 5, Path A begins with block 414, which includes adjusting components of the multiple-fuel engine so that the multiple-fuel engine operates at the next operating state of the set of operating states. The components adjusted at block 414 can include an engine component that was part of the single-fuel engine, such as a diesel fuel pump. The components adjusted at block 414 can also include an engine component that was added to the single-fuel engine during its conversion to a multiple-fuel engine, such as fuel injectors 114. ECU 300 can execute CRPI 314 to adjust the components.

Next, block 416 includes storing calibration data pertaining to components of the multiple-fuel engine adjustable to achieve the next engine operating state. The calibration data for the next engine operating state can be stored in non-transitory computer-readable data storage device, which can be, but is not necessarily, located in an ECU arranged like ECU 300. The stored calibration data can include (i) data representing the engine operating characteristics set and/or measured for the next engine operating state, and data representing the engine operating parameters measured for the next engine operating state.

Next, block 418 includes proceeding to Path C in FIG. 4, which leads to decision block 408. If the question of block 408 is answered as NO, (in other words, if no additional calibration data is desired) then the process leads to block 412, which includes proceeding to path B in FIG. 5.

Returning to FIG. 5, Path B begins with block 420, which includes programming an electronic control unit (ECU) 300 with the stored calibration data 316. CRPI 314 can be programmed into ECU 300 at or substantially at the same time ECU 300 is programmed with calibration data 316. Programming ECU 300 with CRPI 314 and/or calibration data 316 can include storing CRPI 314 and/or calibration data 316 at data storage device 310.

Next, block 422 includes converting a single-fuel engine to a multiple-fuel engine including the programmed ECU and a diesel oxidation catalyst. Conversion of the single-fuel engine can include attaching, to the single-fuel engine, the components of an engine conversion system for a type 1 engine shown in Table 2 above or a subset comprising one or more but not all of the components of the example engine conversion system. The diesel oxidation catalyst attached to the single-fuel engine can be configured as DOC 136. The single-fuel engine for block 422 can be an engine different than the single-fuel engine converted for block 402 as that engine was converted to a multiple-fuel engine in block 402.

### VI. Example Converted Engines

Various single-fuel engines have been converted to multiple-fuel engines using an example engine conversion system described herein or using a subset of the components of an example engine conversion system described herein. The converted engines were manufactured by Caterpillar Inc. (hereinafter, “Caterpillar”), which has headquarters in Peoria, Ill., United States, and Cummins, Inc. (hereinafter “Cummins”), which has headquarters in Columbus, Ind., United States. Particular details of single-fuel engines built by the foregoing engine manufacturer and converted to multiple-fuel engines, and results of testing those engines converted to multiple-fuel engines in accordance with an example embodiment are described below

A. A converted single-fuel engine can include a 1999 Caterpillar 3406 series engine with Tier 1 emission controls and a DOC. That engine is rated at 289 hp and its serial number is 41Z15040. This converted engine was tested using an 8-mode steady-state test cycle (for example, the ISO 8178 standard test cycle) using an engine dynamometer. A new DOC, CATCO part number D3526, installed on the engine was operated for 125 hours prior to the performing the tests so as to pre-condition the DOC. Tables 5 and 6 illustrate measurement data obtained during the tests. Weighted averages from the 8-mode tests performed on this converted engine are 159.6 hp in the single-fuel mode and 155.7 hp in the multiple-fuel mode. A power map mapped for this converted engine operating in the single-fuel mode showed a maximum hp of 305 hp. A power map mapped for this converted engine operating in the multiple-fuel mode showed a maximum hp of 284 hp. The overall fuel consumption while the engine operated in the multiple-fuel mode decreased by 10% as compared to the fuel consumption while the engine operated in the single-fuel mode. Significant reductions in hydrocarbons (HC), carbon monoxide (CO), nitrogen oxides (NOx), and particulate matter (PM) were measured during the 8-mode tests. An example of those measurements is shown in Table 6.

TABLE 5

| | Single-fuel Mode with | | | | Multiple-fuel Mode | |
|---|---|---|---|---|---|---|
| | 100% Diesel | | Multiple-fuel Mode | | % Diesel | |
| RPM | Torque | HP | Torque | HP | Reduction | % LPG |
| 2,000 | 357 | 133 | 467 | 178 | 21.9% | 33.8% |
| 1,900 | 795 | 289 | 769 | 278 | 48.8% | 42.6% |
| 1,800 | 859 | 292 | 808 | 277 | 49.2% | 65.9% |
| 1,700 | 877 | 286 | 833 | 272 | 51.2% | 59.8% |
| 1,600 | 917 | 277 | 871 | 263 | 44.8% | 40.2% |
| 1,500 | 937 | 268 | 906 | 259 | 74.9% | 34.4% |
| 1,400 | 961 | 256 | 911 | 242 | 35.6% | 26.4% |
| 1,300 | 982 | 245 | 1001 | 247 | 22.1% | 19.9% |

| | | |
|---|---|---|
| Average | 43.6% | 40.4% |

TABLE 6

| | HC | CO | NOx | PM |
|---|---|---|---|---|
| Dual Fuel Engine | 0.60 | 2.56 | 2.54 | 0.11 |
| Results after 125 | | | | |
| hours | | | | |
| 1999 Standard | 1.00 | 8.50 | 6.90 | 0.40 |
| % Difference | −40% | −70% | −63% | −73% |
| (Reduction) | | | | |
| Diesel Baseline | 0.16 | 3.54 | 7.44 | 0.14 |
| % Difference | N.A. | −28% | −66% | −21% |
| (Reduction) | | | | |

B. A converted single-fuel engine can include a 2006 Cummins QSM11 series engine with Tier 3 emission controls. That engine is rated at 400 hp and its serial number is 35143799. This converted engine was tested using an 8-mode steady-state protocol using an engine dynamometer. A new DOC, CATCO part number D3526, installed on the engine was operated for 125 hours prior to the performing the tests so as to pre-condition the DOC. Tables 5 and 8 illustrate measurement data obtained during the tests. Weighted averages from the 8-mode tests are 224.0 hp in the single-fuel mode and 223.3 hp in multiple-fuel mode. A power map mapped for this converted engine operating in the single-fuel mode showed a maximum hp of 400 hp. A power map mapped for this converted engine operating in the multiple-fuel mode showed a maximum hp of 400 hp. The overall fuel consumption while the engine operated in the multiple-fuel mode decreased by 12% as compared to the fuel consumption while the engine operated in the single-fuel mode. Significant reductions in carbon monoxide (CO), non-methane hydrocarbons and nitrogen oxides (NMHC-NOx), and particulate matter (PM) were measured during the 8-mode tests. An example of those measurements is shown in Table 8.

TABLE 7

| | Single-fuel Mode with | | | | Multiple-fuel Mode | |
|---|---|---|---|---|---|---|
| | 100% Diesel | | Multiple-fuel Mode | | % Diesel | |
| RPM | Torque | HP | Torque | HP | Reduction | % LPG |
| 2,100 | 1,000 | 400 | 924 | 368 | 39.2% | 33.1% |
| 2,000 | 1,069 | 410 | 1,110 | 420 | 44.6% | 37.5% |
| 1,900 | 1,135 | 409 | 1,126 | 399 | 44.8% | 36.4% |
| 1,800 | 1,204 | 411 | 1,161 | 398 | 47.4% | 43.2% |
| 1,700 | 1,247 | 405 | 1,227 | 395 | 45.5% | 38.9% |
| 1,600 | 1,317 | 400 | 1,280 | 394 | 41.2% | 36.4% |
| 1,500 | 1,362 | 389 | 1,357 | 386 | 42.4% | 27.6% |
| 1,400 | 1,406 | 375 | 1,426 | 384 | 41.1% | 27.4% |

| | | |
|---|---|---|
| Average | 43.3% | 35.1% |

TABLE 8

| | CO | NOx | NMHC-NOx | PM |
|---|---|---|---|---|
| Dual Fuel Engine | 0.12 | 1.52 | 2.52 | 0.12 |
| Results after 125 | | | | |
| hours | | | | |
| 2006 Standard | 2.60 | N.A. | 2.60 | 0.15 |
| % Difference | −95% | N.A. | −16% | −20% |
| (Reduction) | | | | |
| Diesel Baseline | 1.10 | 2.60 | 2.8 | 0.06 |
| % Difference | −89% | −42% | −10% | N.A. |
| (Reduction) | | | | |

C. The two engines described above are referred to as example converted engines. Engines other than those described in this description can be converted to a multiple-fuel engine in accordance with an example embodiment. In that regard, for example, an engine converted from a single-fuel engine to a multiple-fuel engine need not be limited to engines having a displacement within the range of 2.5 and 15 liters and/or a horsepower rating between 100 and 675 HP.

Furthermore, a first multiple-fuel engine can be converted to a second multiple-fuel engine. For instance, a multiple-fuel engine that operates without a DOC and/or without a back pressure sensor could be converted to a multiple-fuel engine comprising a DOC and/or a back pressure sensor. Other engine components described herein, such as one or more components listed in Table 2, can be installed on a multiple-fuel engine to convert the engine from a first type of multiple-fuel engine to a second type of multiple-fuel engine.

### VII. Engine System

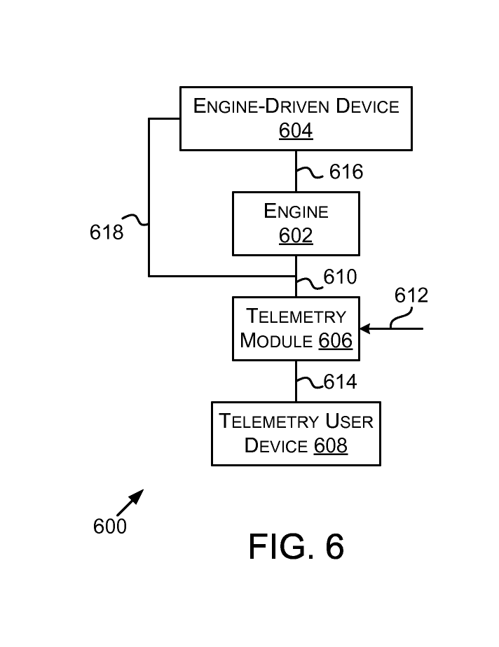

FIG. 6 is a block diagram of an example engine system 600. Engine system 600 can include an engine 602, an engine-driven device 604, a telemetry module 606, and a telemetry user device 608. Engine 602 can be arranged like engine 100, engine 150, or some other single-fuel or multiple-fuel engine. Engine 602 can perform one or more functions described herein as being performed by another engine or a component of another engine.

Engine-driven device 604 can comprise a device driven by (for example, powered by) engine 602. A coupling device, such as a drive shaft, can connect engine 602 to engine-driven device 604. Engine 602 and engine-driven device 604 can be operated at fixed locations, but engine 602 and engine-driven device 604 are not so limited. By way of example, engine-driven device can be arranged as an air compressor, a liquid pump, such as a water pump, a generator, or some combination of two or more of those example devices.

Telemetry module 606 can be arranged to receive information signals from engine 602 and/or engine-driven device 604. Telemetry module 606 can be arranged to transmit those information signals to telemetry user-device 608, which can include one or more telemetry user-devices. The information signals transmitted by telemetry module 606 can be identical to or a modification of the information signals received at telemetry module 606. Telemetry module 606 can be arranged like telemetry module 170. Telemetry module 606 can perform one or more functions described herein as being performed by telemetry module 170.

In accordance with an example in which engine-driven device 604 comprises an air compressor, the information signals provided to telemetry module 606 via data bus 610 or data bus 618 can comprise signals indicating an air pressure, air compressor statistics regarding use of the air compressor, and air compressor diagnostic data. Other examples of the information signals provided to telemetry module 606 when engine-driven device 604 comprises an air compressor are also possible.

In accordance with an example in which engine-driven device 604 comprises a liquid pump, the information signals provided to telemetry module 606 via data bus 610 or data bus 618 can comprise signals indicating a measured flow of liquid entering or exiting the liquid pump, a viscosity rating of liquid flowing into, through, or outside of the liquid pump, liquid pump statistics regarding use of the liquid pump, and liquid pump diagnostic data. Other examples of the information signals provided to telemetry module 606 when engine-driven device 604 comprises a liquid pump are also possible.

In accordance with an example in which engine-driven device 604 comprises a generator, the information signals provided to telemetry module 606 via data bus 610 or data bus 618 can comprise signals indicating an electrical power rating, a voltage level, an amperage level, generator statistics regarding use of the generator, and generator diagnostic data. Other examples of the information signals provided to telemetry module 606 when engine-driven device 604 comprises a generator are also possible.

Telemetry user device 608 can be arranged to receive information signals from telemetry module 606. Telemetry user device 608 can be arranged to present the information signals it receives from telemetry module 606 and present those or a modified form of those information signals. Telemetry user device 608 can be arranged like telemetry user device 174. Telemetry user device 608 can perform one or more functions described herein as being performed by telemetry user device 174.

Data bus 610 can carry data communications between engine 602 and telemetry module 606. Data bus 610 can comprise a wireless communication link, a wired communication link, or a combination of wired and wireless communication links. Data bus 610 can be arranged as data bus 154.

Data bus 618 can carry data communications between engine-driven device 604 and telemetry module 606. Data bus 618 can comprise a wireless communication link, a wired communication link, or a combination of wired and wireless communication links. Data bus 618 can be arranged as data bus 154. Data bus 618 can connect to data bus 610. Alternatively, data bus 618 can connect directly to telemetry module 606 without connecting to data bus 610.

Engine system 600 can include discrete inputs 612. Discrete inputs 612 can comprise at least two ends. A first end of each discrete input 612 can connect to telemetry module 606. A second end of each discrete input 612 can, for example, connect to engine 602 or engine-driven device 604. One or more of discrete inputs 612 can be arranged like discrete inputs 172. One or more of discrete functions 612 can perform one or more functions described herein as being performed by a discrete input 172.

Engine system 600 can include a network 614 to carry information signals from telemetry module 606 to telemetry user device 608. Network 614 can be arranged like network 176. Network 614 can perform one or more functions described herein as being performed by a network 176.

One or more of data bus 610, data bus 618, and network 614 can carry directions to or from the components to which the data bus or network connects.

### VIII. Conclusion

Example embodiments have been described above. Those skilled in the art will understand that changes and modifications can be made to the described embodiments without departing from the true scope and spirit of the present invention, which is defined by the claims.

We claim:

1. An engine conversion system configured for conversion of an engine from a single-fuel engine using a first fuel to a multiple-fuel engine using the first fuel and a second fuel, the engine conversion system comprising:
a first electronic control unit (ECU) configured to control delivery of supply amounts of the first fuel and supply amounts of the second fuel for combustion within the multiple-fuel engine, wherein the first ECU includes one or more inputs to receive data identifying operating characteristics for use in determining the supply amounts of the first fuel and the supply amounts of the second fuel; and
a diesel oxidation catalyst (DOC) configured for installation within an exhaust system of the engine,
wherein conversion of the single-fuel engine to the multiple-fuel engine allows the multiple-fuel engine to operate in a single-fuel mode in which the engine uses the first fuel and in a multiple-fuel mode in which the engine uses the first fuel and the second fuel, and
wherein the second fuel is a substitute for an amount of the first fuel and is injected as vapors into an air intake system of the multiple-fuel engine prior to entering a combustion chamber of the multiple-fuel engine.

2. The engine conversion system of claim 1, further comprising:
an injector rail including one or more fuel injectors configured to inject the second fuel as a vapor;
a mixer pin that receives the second fuel injected by the one or more fuel injectors and supplies the second fuel as a vapor into an air intake system of the engine;
a pressure regulator that limits a pressure of the second fuel provided to the injector rail at or below a maximum fuel pressure threshold;
a first temperature sensor that provides to the first ECU, via a first of the one more inputs, data for identifying temperatures of the second fuel; and
a first pressure sensor that provides to the first ECU, via a second of the one more inputs, data for identifying pressures of the second fuel.

3. The engine conversion system of claim 2,
wherein a mechanical fuel control system is used to control injection of the supply amounts of the first fuel delivered to the engine configured as the multiple-fuel engine, and
wherein, prior to any component of the engine conversion system being attached to the engine to begin conversion of the engine from the single-fuel engine to the multiple-fuel engine, at least a portion of the mechanical fuel control system is attached to the engine.

4. The engine conversion system of claim 3, further comprising:
a fuel rack actuator within a fuel pump of the mechanical fuel control system;
a first position sensor that provides to the first ECU, via a third of the one more inputs, data for identifying a position of a fuel rack at the fuel pump;
a second position sensor that provides to the first ECU, via a fourth of the one more inputs, data for identifying positions of a throttle of the engine;
a second temperature sensor that provides to the first ECU, via a fifth of the one more inputs, data for identifying temperatures of intake air within the air intake system of the engine;
a third temperature sensor that provides to the first ECU, via a sixth of the one more inputs, data for identifying temperatures of coolant within a cooling system of the engine;
a revolutions per minute (RPM) sensor that provides to the first ECU, via a seventh of the one more inputs, data for identifying RPM at which the engine is operating;
a fourth temperature sensor that provides to the first ECU, via an eighth of the one more inputs, data for identifying temperatures of exhaust gas within an exhaust system of the engine; and
a second pressure sensor that provides to the first ECU, via a ninth of the one more inputs, data for identifying pressures of air within the air intake system of the engine;

5. The engine conversion system of claim 2,
wherein an electronic fuel control system is used to control injection of the supply amounts of the first fuel delivered to the engine configured as the multiple-fuel engine,
wherein, prior to any component of the engine conversion system being attached to the engine to begin conversion of the engine from the single-fuel engine to the multiple-fuel engine, at least a portion of the electronic fuel control system is attached to the engine.
wherein the electronic fuel control system comprises a second ECU that connects to a data link,
wherein at least one input of the one or more inputs of the first ECU is configured to receive data transmitted from the second ECU via the data link, and
wherein the data received via the data link comprises data identifying at least one of the operating characteristics for use in determining the supply amounts of the first fuel and the supply amounts of the second fuel.

6. The engine conversion system of claim 2,
wherein the first ECU comprises a processor and a non-transitory computer-readable data storage device storing computer-readable program instructions, and
wherein the computer-readable program instructions comprise program instructions executable by the processor to determine, for all fueling ranges when the engine operates as the multiple-fuel engine, the supply amounts of the second fuel for combustion within the multiple-fuel engine.

7. The engine conversion system of claim 6,
wherein the data storage device stores one or more threshold parameters,
wherein the processor of the first ECU executes computer-readable program instructions stored at the data storage device to compare one or more of the received operating characteristics with a respective threshold parameter of the one or more threshold parameters to determine whether the engine should transition from operating in the multiple-fuel mode to operating in the single-fuel mode, and
wherein if the processor of the first ECU determines that the engine should transition from operating in the multiple-fuel mode to operating in the single-fuel mode, the processor of the first ECU executes computer-readable program instructions stored at the data storage device to cause the engine to transition from operating in the multiple-fuel mode to operating in the single-fuel mode.

8. The engine conversion system of claim 2, further comprising:
a first backpressure sensor that provides to the first ECU, via a third of the one or more inputs, data for identifying backpressures on exhaust gases within an exhaust pipe between the combustion chamber and the DOC; and
a second backpressure sensor that provides to the first ECU, via a fourth of the one or more inputs, data for identifying backpressures on exhaust gases within an exhaust pipe between the DOC and an exhaust exit,
wherein the engine, while configured as the multiple-fuel engine and operating in either the single-fuel mode or the multiple-fuel mode, operates within exhaust backpressure limits specified for the engine configured as the single-fuel engine.

9. The engine conversion system of claim 8,
wherein the engine has a displacement between 2.5 liters and 15 liters inclusive, and
wherein the engine has a maximum horsepower rating between 100 horsepower and 675 horsepower inclusive.

10. The engine conversion system of claim 8, further comprising:
a telemetry module that transmits data regarding the operating characteristics of the multiple-fuel engine to one or more telemetry user-devices,
wherein the telemetry module can transmit the data regarding the operating characteristics via a wired communication link or a wireless communication link.

11. The engine conversion system of claim 10, wherein the telemetry module receives at least a portion of the data regarding the operating characteristics of the multiple-fuel engine from at least one sensor, on the multiple-fuel engine, that is connected to the telemetry module via a wired link.

12. The engine conversion system of claim 10, wherein the telemetry module receives at least a portion of the data regarding the operating characteristics of the multiple-fuel engine from the first ECU via a data bus connected to the telemetry module and the first ECU.

13. The engine conversion system of claim 2,
wherein the first fuel comprises diesel fuel, and
wherein the second fuel comprises a fuel selected from the group consisting of liquid petroleum gas, propane, compressed natural gas, butane, and a biofuel.

14. The engine conversion system of claim 2,
wherein the first fuel comprises diesel fuel, and
wherein the second fuel comprises a combination of two or more fuels other than diesel fuel.

15. The engine conversion system of claim 1, further comprising:
an exhaust temperature sensor that provides to the first ECU, via a first of the one more inputs, data for identifying temperatures of exhaust gas within an exhaust system of the engine,
wherein the first ECU determines temperatures of exhaust within the exhaust system from the data provided to the first ECU from the exhaust temperature sensor,
wherein, if the first ECU determines the exhaust temperature within the exhaust system is below a minimum exhaust temperature threshold while the engine is operating in a multiple-fuel mode, the first ECU changes amounts of the first fuel and the second fuel being supplied to the engine to cause the exhaust temperature in the exhaust system to increase above the minimum exhaust temperature threshold but below a maximum engine temperature threshold, and
wherein, if the first ECU determines the exhaust temperature within the exhaust system exceeds the maximum exhaust temperature threshold while the engine is operating in a multiple-fuel mode, the first ECU changes amounts of the first fuel and the second fuel being supplied to the engine to cause the exhaust temperature in the exhaust system to decrease below the maximum exhaust temperature threshold but above the minimum exhaust temperature threshold.

16. The engine conversion system of claim 1, wherein the engine conversion system is certified by the California Environmental Protection Agency Air Resources Board via a B-series executive order such that the system can be sold within California for use on at least one engine type.

17. An engine conversion system configured for conversion of an engine from a single-fuel engine using a first fuel to a multiple-fuel engine using the first fuel and a second fuel, the system comprising:
an electronic control unit (ECU) configured to control delivery of supply amounts of the first fuel and supply amounts of the second fuel for combustion within the multiple-fuel engine, wherein the ECU includes one or more inputs to receive data identifying operating characteristics for use in determining the supply amounts of the first fuel and the supply amounts of the second fuel;
a diesel oxidation catalyst (DOC) configured for installation within an exhaust system of the engine;
a first back pressure sensor configured for installation within the exhaust system between combustion chambers of the engine and the DOC; and
a second back pressure sensor configured for installation within the exhaust system between the DOC and an exhaust exist,
wherein conversion of the single-fuel engine to the multiple-fuel engine allows the multiple-fuel engine to operate in a single-fuel mode in which the engine uses the first fuel and in a multiple-fuel mode in which the engine uses the first fuel and the second fuel, and
wherein the second fuel is a substitute for an amount of the first fuel and is injected as vapors into an air intake system of the multiple-fuel engine prior to entering a combustion chamber of the multiple-fuel engine.

18. The engine conversion system of claim 17,
wherein a first of the one more inputs of the ECU receives data from the first back pressure sensor,
wherein a second of the one more inputs of the ECU receives data from the second back pressure sensor,
wherein the ECU uses the data from the first back pressure sensor and the data from the second back pressure sensor to determine whether the engine should transition from operating in the multiple-fuel mode to the single-fuel mode, and
wherein if the ECU determines that the engine should transition from operating in the multiple-fuel mode to the single-fuel mode, the ECU transitions to operating in the single-fuel mode.

19. The engine conversion system of claim 18,
wherein the ECU comprises a computer-readable calibration for a given engine type,
wherein the computer-readable calibration for the given engine type comprise a minimum exhaust backpressure threshold and a maximum exhaust backpressure threshold,
wherein the ECU is configured to use the computer-readable calibration for the given engine type, and
wherein the ECU determines that the engine should transition from operating in the multiple-fuel mode to the single-fuel mode by determining that the data from the first back pressure sensor and/or the data from the second back pressure sensor indicates exhaust backpressure in the exhaust system is below the exhaust backpressure threshold and or above the maximum exhaust backpressure threshold.

20. A method for converting a single-fuel engine that uses a first fuel to a multiple-fuel engine that uses the first fuel and a second fuel, the method comprises:
attaching, to an engine exhaust system of the single-fuel engine, an exhaust temperature sensor, a first back pressure sensor, a second back pressure sensor, and a diesel oxidation catalyst;
attaching, to a mechanical fuel control system of the single-fuel engine, a diesel rack actuator and a diesel rack position sensor;
attaching, to the single-fuel engine, operator controls configured to select whether the multiple-fuel engine operates in a single-fuel mode or a multiple-fuel mode;
attaching, to the single-fuel engine, a fuel supply system including a fuel storage device to store the second fuel, fuel supply lines to transport the second fuel within the fuel supply system, a solenoid valve, a fuel regulator, an injector rail assembly, one or more fuel injectors, and a mixer pin assembly; and
attaching, to the single-fuel engine, an electronic control unit, an air intake pressure sensor, an air intake temperature sensor, a throttle position sensor, a revolutions per minute (RPM) sensor, a fuel temperature sensor, a fuel pressure sensor, and an engine coolant temperature sensor.

21. A method for converting a single-fuel engine that uses a first fuel to a multiple-fuel engine that uses the first fuel and a second fuel, the method comprises:
attaching, to an engine exhaust system of the single-fuel engine, a first back pressure sensor, a second back pressure sensor, and a diesel oxidation catalyst;
attaching, to the single-fuel engine, operator controls configured to select whether the multiple-fuel engine operates in a single-fuel mode or a multiple-fuel mode;
attaching, to the single-fuel engine, a fuel supply system including a fuel storage device to store the second fuel, fuel supply lines to transport the second fuel within the fuel supply system, a solenoid valve, a fuel regulator, an injector rail assembly, one or more fuel injectors, and a mixer pin assembly; and
attaching, to the single-fuel engine, a first electronic control unit (ECU) arranged to communicate with a second ECU that is part of the single-fuel engine via a data link,
wherein the first ECU receives sensor data from the second ECU to determine amounts of the second fuel to be supplied to combustion chambers within the engine, and
wherein the sensor data represents measurement data received from one or more sensors that were part of the single-fuel engine prior to conversion of the single-fuel engine to the multiple-fuel engine.

22. A multiple-fuel engine produced by converting a single-fuel engine to the multiple-fuel engine, the single-fuel engine comprising an engine block that forms at least a portion of multiple combustion chambers, the single-fuel engine further comprising an air intake system, a fuel storage device storing a first fuel, a fuel pump for the first fuel, and an exhaust system for removal of exhaust gases produced, at least in part, within the engine block, the multiple-fuel engine comprising:
a fuel storage device storing a second fuel;
an electronic control unit (ECU) configured to control delivery of supply amounts of the first fuel and supply amounts of the second fuel for combustion within multiple-fuel engine, wherein the ECU includes one or more inputs that receive data identifying operating characteristics of the multiple-fuel engine, and wherein the ECU executes program instructions that use the received data to determine the supply amounts of the first fuel and the supply amounts of the second fuel; and
a diesel oxidation catalyst (DOC) installed within the exhaust system,
wherein the multiple-fuel engine can operate in a single-fuel mode in which the multiple-fuel engine uses the first fuel,
wherein the multiple-fuel engine can operate in a multiple-fuel mode in which the multiple-fuel engine uses the first fuel and the second fuel, and
wherein the second fuel is a substitute for an amount of the first fuel and is injected as vapors into the air intake system of the multiple-fuel engine.

23. The multiple-fuel engine of claim 22, further comprising at least one wireless sensor to provide data identifying operating characteristics of the multiple-fuel engine to an input of the ECU via an air interface.
